(19) United States
(12) Patent Application Publication
(10) Pub. No.: US 2026/0127486 A1
(43) Pub. Date: May 7, 2026

(54) SYNTHETIC DATA TRANSPARENCY

(71) Applicant: Wells Fargo Bank, N.A., San Francisco, CA (US)

(72) Inventors: Marco Arriaga, Somerset, NJ (US); Jasmine de Gaia, Lewis Center, OH (US); Qian Cao, New Rochelle, NY (US)

(21) Appl. No.: 18/938,017

(22) Filed: Nov. 5, 2024

(51) Int. Cl. G06N 20/00

(52) U.S. Cl. CPC G06N 20/00

(57) ABSTRACT

This disclosure describes techniques for collecting and storing data about how synthetic data is created by a data generation model. In one example, this disclosure describes a method that includes generating, by a computing system and based on a source dataset, a plurality of synthetic data items; storing, by the computing system, metadata about how the plurality of synthetic data items were generated; outputting, by the computing system, a user interface presenting information about the plurality of synthetic data items; detecting, by the computing system and based on interactions with the user interface, a request to present information about one or more specific synthetic data items included in the plurality of synthetic data items; and outputting, by the computing system based on the metadata and responsive to the request, an updated user interface presenting information about how the one or more specific synthetic data items were generated.

### TECHNICAL FIELD

This disclosure relates to data processing, and more specifically, to techniques for managing synthetic data generated by a model.

### BACKGROUND

Synthetic data is artificially generated information that mimics real-world data and is generated using a variety of techniques that aim to replicate the statistical properties of the real-world data. For example, synthetic data can be generated using relatively simple and transparent methods, such as rules-based data generation systems. Increasingly, however, synthetic data is generated using more complicated and less transparent techniques, such as through neural networks. Once generated, synthetic data is used for a variety of purposes, including to train machine learning models.

### SUMMARY

This disclosure describes techniques for collecting and storing information about how synthetic data is created, thereby enabling a data traceability or data lineage capability that creates transparency around the synthetic data generation process. The disclosed techniques involve generating metadata about the process by which synthetic data is generated. The metadata identifies attributes of the source data used to generate synthetic data, the model or models used to generate the synthetic data, and other information about the process. Metadata could be generated by the model while synthetic data is created or generated at a different time based on information logged during creation of synthetic data. For example, state information for operations being performed at a record level by a model generating the synthetic data may be collected and logged, and then used to generate metadata.

As described herein, the metadata can be used as the basis for visualizations about the synthetic data (e.g., a chart, distribution, graph, or similar illustration), providing insights into how a given instance or set of instances of synthetic data were generated. In some examples, such a visualization might reveal that a given instance of synthetic data was generated using a specific model, from a specified set of data sources derived over an identified time frame. Visualizations may provide information about many other attributes of the synthetic data, the source data, and/or the models used to generate the synthetic data. Metadata, visualizations, and other information about the synthetic data may be used in various types of analyses, which may involve determining whether the synthetic data was generated appropriately, whether the generated synthetic data is suitable for being used for a particular purpose, or whether the synthetic data complies with third-party or regulatory requirements.

In some examples, this disclosure describes operations performed by a computing system in accordance with one or more aspects of this disclosure. In one specific example, this disclosure describes a method comprising generating, by a computing system and based on a source dataset, a plurality of synthetic data items; storing, by the computing system, metadata about how the plurality of synthetic data items were generated; outputting, by the computing system, a user interface presenting information about the plurality of synthetic data items; detecting, by the computing system and based on interactions with the user interface, a request to present information about one or more specific synthetic data items included in the plurality of synthetic data items; and outputting, by the computing system based on the metadata and responsive to the request, an updated user interface presenting information about how the one or more specific synthetic data items were generated.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

### BRIEF DESCRIPTION OF THE DRAWINGS

FIG. 1 is a conceptual diagram of system in which synthetic data is generated, evaluated, and used to train a model, in accordance with one or more aspects of the present disclosure.

FIG. 2 is a block diagram of system in which synthetic data is generated, evaluated, and used to train a model, in accordance with one or more aspects of the present disclosure.

FIG. 3A through FIG. 3F are conceptual diagrams illustrating example user interfaces presented by a user interface device, in accordance with one or more aspects of the present disclosure.

FIG. 4 is a flow diagram illustrating operations performed by an example computing system, in accordance with one or more aspects of the present disclosure.

Although each of these Figures are referenced herein in connection with the description of one or more specific examples, such examples are merely illustrative, and each Figure can be used to provide support for other examples not specifically described herein. Accordingly, examples described herein with reference to one or more the Figures should not be construed to narrow the scope or spirit of the subject matter illustrated or otherwise disclosed herein.

### DETAILED DESCRIPTION

Synthetic data can play an important role in artificial intelligence (AI) by providing a versatile and scalable solution for training and testing AI models. Unlike real-world data, synthetic data can be generated in vast quantities and can be tailored to specific needs, ensuring a diverse and comprehensive dataset. This is particularly beneficial in scenarios where real data is scarce, expensive, or sensitive, such as in medical research or financial services. By using synthetic data, model developers can simulate a wide range of conditions and edge cases, improving the robustness and accuracy of their models, and enabling more extensive experimentation and validation of algorithms.

Modern techniques for generating synthetic data provide the ability to create large, diverse datasets without the privacy concerns associated with real data. This is useful in many fields, such as healthcare, because synthetic data can be used to protect patient confidentiality. If generated properly, synthetic data does not contain any real personal or private information and does not contain any actual data points from the original source datasets (which typically contain real-world data).

Synthetic data can also help overcome the limitations of small or imbalanced datasets, providing a more robust training ground for machine learning models. Additionally, synthetic data techniques allow for the testing of algorithms under a wide range of scenarios, enhancing their generalizability and performance. By using synthetic data, researchers and developers can innovate more freely and safely, accelerating the development of advanced models.

However, a common concern for data scientists using synthetic data stems from what is often a lack of transparency, meaning data scientists might not have a clear understanding of how and why a given item of synthetic data has been generated. This lack of understanding often results in a lack of confidence in the synthetic data, since the data scientist does not know exactly where the data is coming from or what logic was used to generate it. This disclosure describes techniques for implementing a traceability process that logs sufficient data about how each instance of synthetic data is created to enable a data scientist to determine and/or visualize what source records were used to generate an instance of synthetic data and what logic was applied to create the synthetic data.

For example, processes described herein may involve maintaining state information for operations being performed at a record level when synthetic data is created. Techniques described herein use this state information to create metadata that can be used as the basis for a visualization (e.g., a chart, distribution, graph, or similar illustration) of the logged data, providing insights into how a given instance of synthetic data was generated. Such a visualization might reveal that a given instance of synthetic data was generated from a specific model, from a specified data source derived over a given time frame, and/or other attributes of the process. Based on this information, a data scientist that is experienced in the data would likely be able to accurately assess whether the synthetic data generation process is, at least at a high level, producing synthetic data appropriately. Such an assessment would enhance the data scientist's confidence in the resulting synthetic data.

The disclosed techniques may also be used to demonstrate to interested parties (e.g., corporate management, auditors, or government regulators) that a given set of synthetic data was derived from a valid production dataset with appropriate correlations or distributions of data. In general, this ability to provide information about specific instances of synthetic data enables a data traceability or data lineage capability that creates transparency around the synthetic data generation process.

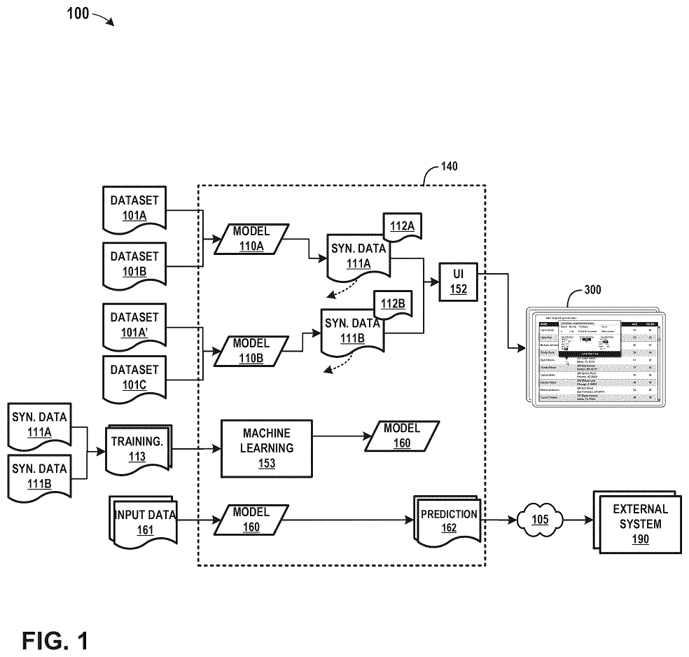

FIG. 1 is a conceptual diagram of system in which synthetic data is generated, evaluated, and used to train a model, in accordance with one or more aspects of the present disclosure. FIG. 1 illustrates model development system 140, which may include multiple models generating synthetic data. For example, model development system 140 includes model 110A and model 110B (“models 110”). Each of models 110 represent models trained to generate synthetic data having characteristics similar to the data the model receives as input. Model development system 140 is illustrated with only two models 110, but any number of models may be used.

In FIG. 1, models 110 generate synthetic data 111 (e.g., synthetic data 111A and 111B) based on source, original, real world, and/or production data, such as source datasets 101A, 101B, 101C (“source datasets 101”). Such source datasets 101 may be updated from time to time, and those updated versions of the source datasets 101 may also be used as input to models 110. For example, source dataset 101A′ is illustrated in FIG. 1, and is intended to represent a modified or updated version of source dataset 101A.

Models 110 generate synthetic data 111 using any of a variety of techniques that seek to replicate the statistical properties of source datasets 101 without containing any actual data points from the source datasets 101. In some examples, model 110 may use neural network-based techniques to generate synthetic data 111. Such techniques may include use of generative adversarial networks (GANs), variational autoencoders (VAEs), or other artificial intelligence processes. In other examples, models 110 may use other techniques to generate synthetic data, such as rules-based or related techniques. As described herein, when each of models 110 generate synthetic data 111, those models (or another process) generate metadata 112 about the process of generating synthetic data 111.

Model development system 140 also includes user interface system or subsystem 152, which may use metadata 112 to generate visualizations or user interfaces 300. Such user interfaces 300 may provide information and insights about the synthetic data 111 generated by models 110, about the source datasets 101 used to generate the synthetic data 111, and/or about other aspects of the process of generating various sets of synthetic data 111. In general, such user interfaces 300 enable a data scientist to evaluate synthetic data 111 and/or the process by which synthetic data 111 was generated.

In some examples, model development system 140 also includes a machine learning system or subsystem 153. Machine learning system 153 may perform functions relating to training or retraining various models using synthetic data 111. For example, machine learning system 153 may use the synthetic data 111 generated by models 110 to create sets of training data 113. Training data 113 may include some or all of the generated synthetic data (e.g., synthetic data 111A and/subset of synthetic data 111B). Machine learning system 153 uses training data 113 to train one or more models, such as production model 160. Once trained, production model 160 may be applied to input data to generate predictions 162. Such predictions 162 may be used to control one or more external systems 190 over network 105.

The operation of FIG. 1 can be illustrated through an example described in the context of FIG. 1, where model development system 140 generates synthetic data used to train production model 160. For instance, source dataset 101A and source dataset 101B are presented as input to model 110A. In response, model 110A generates synthetic data 111A, which may have characteristics very similar to the source data included in source datasets 101A and 101B. When generating synthetic data 111A, model 110A generates metadata 112A associated with synthetic data 111A. Metadata 112A includes information about attributes of synthetic data 111A, information about attributes of the input used to generate synthetic data 111A (i.e., source dataset 101A and source dataset 101B), and information about the process applied by model 110A to generate synthetic data 111A.

In some examples, metadata 112A is stored with synthetic data 111A, helping to identify synthetic data 111A as synthetic. For example, metadata 112A may take the form of or include a watermark or stamp, effectively tagging the synthetic data 111A so consumers of synthetic data 111A (data scientists, administrators, users, systems) know that the data items included within synthetic data 111A are synthetic and not real. In some examples, such a watermark or other indicia might have a form or structure to make it readily apparent that data items from synthetic data 111A are synthetic, which may enable consumers of synthetic data 111A from engaging in time-consuming research to make such a determination. In some examples, metadata 112A may travel with and/or live with synthetic data 111A, which may facilitate identifying synthetic data 111A as synthetic.

Model development system 140 may generate additional synthetic data using other models. For instance, again with reference to FIG. 1, source dataset 101A′ and source dataset 101C are presented as input to model 110B. Model 110B may be a different model that, like model 110A, is trained to generate synthetic data having characteristics similar to the data it receives as input. In response to receiving source dataset 101A′ and source dataset 101C, model 110B generates synthetic data 111B along with metadata 112B. Metadata 112B includes information about attributes of synthetic data 111B, information about attributes of the input used to generate synthetic data 111B (i.e., source dataset 101A′ and source dataset 101C), and information about the process applied by model 110B to generate synthetic data 111B. Metadata 112B may live with, travel with, be integrated with, and/or otherwise be associated with synthetic data 111B, in a manner similar to that described above in connection with metadata 112A and synthetic data 111A.

Model development system 140 may be used to evaluate the process by which synthetic data 111A and 111B were generated. For instance, in FIG. 1, model development system 140 outputs information about metadata 112A and/or metadata 112B to user interface system 152. User interface system 152 of model development system 140 uses metadata 112A and/or metadata 112B to generate visualizations describing or illustrating information about source datasets 101, models 110, and/or some or all of synthetic data 111. User interface system 152 outputs these visualizations as one or more user interfaces 300. In some examples, user interface system 152 presents such user interfaces 300 on a display device for evaluation by a data scientist, by a computing system, or by an artificially intelligent agent or other system.

In general, user interfaces 300 may provide information about source datasets 101 and models 110 used to generate various instances of synthetic data 111, and may be derived from the collected or logged information underlying or included within metadata 112. For example, user interface 300 may provide information about the source, size, volume, freshness, completeness, and timestamps associated with source dataset 101 used to generate specific synthetic data 111. The information may also indicate whether an entire source dataset 101 was used or only a portion of it, or whether a source dataset 101 was amended or updated and when. User interfaces 300 may also provide information about the models 110 used to generate specific synthetic data 111 and whether any specific constraints were placed on the models 110 when generating synthetic data 111 (e.g., a given model 110 was directed to generate synthetic data 111 for certain U.S. states or having specific attribute distributions). To generate such information, user interface system 152 may analyze source datasets 101, metadata 112, and the synthetic data 111 associated with that metadata 112.

Model development system 140 may act on evaluations performed using the visualizations. For example, if an evaluation suggests that there are flaws in synthetic data 111 or flaws in the process by which synthetic data 111 was created, model development system 140 may modify (e.g., in response to input from a data scientist) one or more source datasets 101 and/or modify how or which models 110 generate synthetic data 111. Model development system 140 may then regenerate synthetic data 111 and associated metadata 112 for further evaluation. This process continues until the evaluation of the synthetic data 111 and/or the process by which synthetic data 111 was created is deemed acceptable. The resulting synthetic data 111 is then considered ready for use in later processes.

Model development system 140 may train a model using the synthetic data 111. For instance, machine learning system 153 of model development system 140 receives training data 113 as input. In some examples, machine learning system 153 may receive either synthetic data or actual data (e.g., customer data, information about input received by production business systems) as training data 113. However, in the example being described, machine learning system 153 uses synthetic data as training data 113, which may be the synthetic data deemed acceptable after evaluation, as described above (e.g., versions of synthetic data 111A and synthetic data 111B, as shown in FIG. 1). Machine learning system 153 trains production model 160 using training data 113.

Once trained, production model 160 may generate predictions. For instance, in FIG. 1, production model 160 may be deployed in an environment in which it is presented with a series of input data 161. In response to input data 161, production model 160 generates predictions 162. In some examples, predictions 162 may be part of a larger system involving other systems (e.g., external system 190). For instance, depending on the nature of production model 160, predictions 162 made by production model 160 may serve as control signals that control the operation of one or more external systems 190. Specifically, model development system 140 may send control signals to one or more external systems 190, instructing one or more of external systems 190 to perform a specific operation (e.g., adjust credit scores, enable or disable a healthcare process, modify network operations, generate an alert, enable or disable access to resources). Accordingly, model development system 140 may control the operation of such external systems through predictions 162 made by production model 160.

As described, production model 160 is capable of making inferences or predictions when presented with input data, such as input data 161. If trained effectively, production model 160 will exhibit skill at making predictions about data that is similar to training data 113. For example, production model 160 may be a supervised learning model trained to predict creditworthiness based on attributes of credit card customers. If input data 161 is sufficiently similar to training data 113, predictions made by production model 160 about the creditworthiness of credit card customers described in input data 161 will be relatively accurate. Therefore, if training data 113 consists of only synthetic data 111, it is important that synthetic data 111 be very similar to actual data (like source datasets 101 or input data 161) that production model 160 will use to make predictions. However, determining whether synthetic data 111 is sufficiently similar to actual data (e.g., source datasets 101 or input data 161) is often difficult.

By providing insights to data scientists (or to a system capable of performing an analysis) about how well synthetic data 111 matches source datasets 101, it may be possible to ensure that synthetic data 111 is of sufficiently high quality to serve as effective training data 113. Effective training data 113 is more likely to result in accurate predictions being made by production model 160.

In some examples, a system implementing the described techniques may provide the capability to selectively enable and disable generation of metadata 112 and the collection of any information underlying that metadata. Since collecting information underlying metadata 112 would likely require access to the private data included in the original source data, it may be useful, in at least some examples, to perform such collection operations only during calibration or initial testing of the synthetic data generation process. In other contexts, such as during production operations, it may be beneficial to disable such collection operations both for privacy and performance reasons. For example, disabling collection of data underlying metadata 112 may help ensure that no private data derived from the original source data is exposed during operation of the production system. In addition, because the logs and the traceability data generated by a system that implements the described techniques may be voluminous, disabling collection of data underlying metadata 112 may improve the efficiency of processes associated with creating synthetic data. Accordingly, although metadata 112 could be generated by production systems, some production systems (production versions of model development system 140) might not collect data underlying metadata 112 and/or generate metadata 112.

Techniques described herein may provide certain technical advantages. For instance, by maintaining information about how synthetic data is generated, the disclosed techniques may provide transparency into the process of generating synthetic data, and enable identification of synthetic data that might not adequately preserve private information in the original source data. When synthetic data that might expose private information is identified, steps can be taken to rectify and improve the synthetic data generation process. This transparency and ability to identify problems with generated synthetic data may provide a level of confidence and/or assurance to data scientists that the synthetic data has been accurately and properly generated.

In addition, by maintaining information about how instances of synthetic data are generated, other processes can be performed quickly and efficiently, such as debugging, calibration, and evaluation of the quality of synthetic data. This may lead to faster deployment of models trained with synthetic data. This may also lead to development of models that generate more accurate predictions, without revealing private information and without any inappropriate bias.

Further, by maintaining information about how synthetic data is generated, it is possible to effectively and quickly respond to inquiries about deployed models or the process for training those models. Such inquiries may originate from regulatory agents, corporate management, privacy watchdogs, and other interested parties.

Still further, by choosing environments and contexts in which to collect information for generating metadata 112, privacy can be effectively preserved, and performance can be maintained. For example, by applying some of the techniques described herein only at the calibration or testing stage, private data included in the original source data is less likely to be exposed. Further, by logging information about the synthetic data generation process only during the calibration or testing stage, the efficiency of the other environments (e.g., production environments) can be maintained.

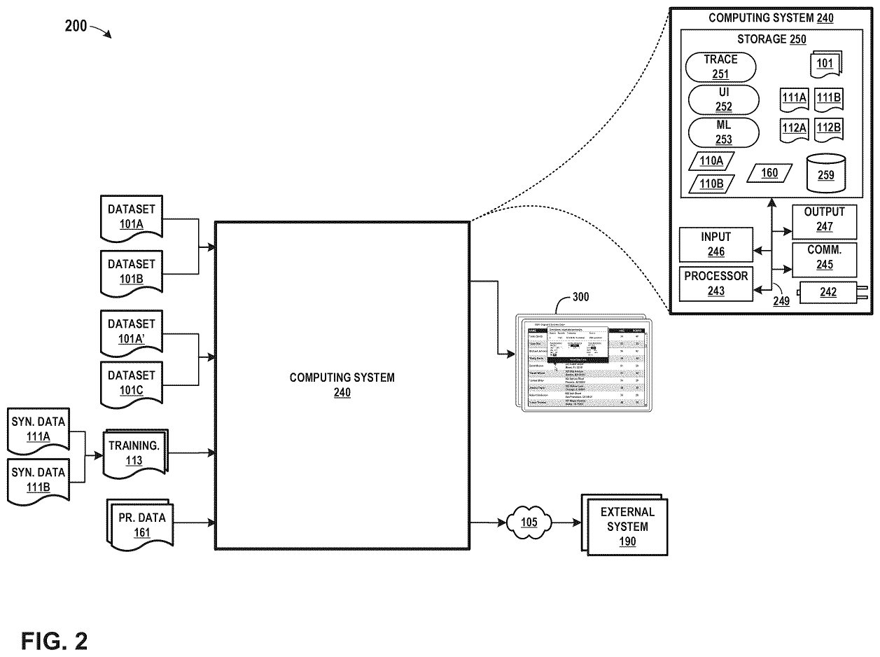

FIG. 2 is a block diagram of system in which synthetic data is generated, evaluated, and used to train a model, in accordance with one or more aspects of the present disclosure. System 200 of FIG. 2 includes many of the same elements of system 100 described in connection with FIG. 1. Elements illustrated in FIG. 2 may correspond to earlier-described elements sharing the same reference numeral.

Also illustrated in FIG. 2 is a block diagram depiction of computing system 240, which may be considered an example or alternative implementation of model development system 140 of FIG. 1. Computing system 240 of FIG. 2 may operate in a manner similar to model development system 140 illustrated in FIG. 1. For example, computing system 240 may accept source datasets 101, training data 113, and input data 161 as input as described in connection with FIG. 1. Also, computing system 240 may generate visualizations (e.g., user interfaces 300) and control one or more external systems 190 over network 105 as described in connection with FIG. 1. Computing system 240 is illustrated in FIG. 2 to facilitate a description of certain components, modules, and other aspects of a computing system that may implement a system for generating synthetic data, providing traceability or transparency relating to the synthetic data, and making inferences in production. Computing system 240 is also illustrated in FIG. 2 to facilitate a description of how such a computing system may operate in accordance with techniques described herein.

For ease of illustration, computing system 240 is depicted in FIG. 2 as a single computing system. However, in other examples, computing system 240 may be implemented through multiple devices or computing systems distributed across a data center, multiple data centers, multiple cloud networks, or otherwise. For example, separate computing systems may implement functionality described herein as being performed by each of various modules of computing system 240, including tracing module 251, user interface module 252, and machine learning module 253. Alternatively, or in addition, modules illustrated in FIG. 2 as included within computing system 240 may be implemented through distributed virtualized compute instances (e.g., virtual machines, containers) of a data center, cloud computing system, server farm, and/or server cluster.

In FIG. 2, computing system 240 is shown with underlying physical hardware that includes power source 242, one or more processors 243, one or more communication units 245, one or more input devices 246, one or more output devices 247, and one or more storage devices 250. One or more of the devices, modules, storage areas, or other components of computing system 240 may be interconnected to enable inter-component communications (physically, communicatively, and/or operatively). In some examples, such connectivity may be provided by through communication channels, which may include a system bus (e.g., communication channel 249), a network connection, an inter-process communication data structure, or any other method for communicating data. Although computing system 240 of FIG. 2 may be considered an example implementation of model development system 140 of FIG. 1, other implementations are possible.

In the example shown, power source 242 of computing system 240 may provide power to one or more components of computing system 240. Power source 242 may receive power from an alternating current (AC) power supply in a building, data center, or other location. In some examples, power source 242 may be or include a battery or a device that supplies direct current (DC). Power source 242 may have intelligent power management or consumption capabilities, and such features may be controlled, accessed, or adjusted by processors 243 to intelligently consume, allocate, supply, or otherwise manage power.

One or more processors 243 of computing system 240 may implement functionality and/or execute instructions associated with computing system 240 or associated with one or more modules illustrated herein and/or described herein. One or more processors 243 may be, may be part of, and/or may include processing circuitry that performs operations in accordance with one or more aspects of the present disclosure. Such processors may be mobile processors, desktop processors, server processors, compute nodes, virtualized processors, neural processing units or NPUs, graphics processing units or GPUs, and/or other types of processors or processing circuitry. Processors 243 may execute the instructions of one or more processes executing on computing system 240 and may implement functionality of such processes.

One or more communication units 245 of computing system 240 may communicate with devices external to computing system 240 by transmitting and/or receiving data, and may operate, in some respects, as both an input device and an output device. Communication units 245 may enable computing system 240 to communicate with other computing devices and systems using any appropriate communication protocol (e.g., TCP/IP) and over any appropriate medium. In some or all cases, one or more communication units 245 may communicate with other devices or computing systems over a network. For example, communication units 245 may enable computing system 240 to communicate with other systems or devices (e.g., external systems 190) over a network (e.g., network 105).

One or more input devices 246 may represent any input devices of computing system 240, and one or more output devices 247 may represent any output devices of computing system 240. Input devices 246 and/or output devices 247 may generate, receive, and/or process output from any type of device capable of outputting information to a human or machine. For example, one or more input devices 246 may generate, receive, and/or process input in the form of electrical, physical, audio, image, and/or visual input (e.g., peripheral device, keyboard, microphone, camera). Correspondingly, one or more output devices 247 may generate, receive, and/or process output in the form of electrical and/or physical output (e.g., peripheral device, actuator).

One or more storage devices 250 within computing system 240 may store information for processing during operation of computing system 240. Storage devices 250 may store program instructions and/or data associated with one or more of the modules described in accordance with one or more aspects of this disclosure. One or more processors 243 and one or more storage devices 250 may provide an operating environment or platform for such modules, which may be implemented as software, but may in some examples include any combination of hardware, firmware, and software. One or more processors 243 may execute instructions and one or more storage devices 250 may store instructions and/or data of one or more modules. The combination of processors 243 and storage devices 250 may retrieve, store, and/or execute the instructions and/or data of one or more applications, modules, or software. Processors 243 and/or storage devices 250 may also be operably coupled to one or more other software and/or hardware components, including, but not limited to, one or more of the components of computing system 240 and/or one or more devices or systems illustrated or described as being connected to computing system 240.

Tracing module 251 may perform functions relating to tracking operations performed when synthetic data is generated. Such operations may involve logging data about how synthetic data is created to generate metadata 112, which may enable a data scientist to determine what source records were used to generate various items of synthetic data. In some cases, information about versions of source data, which models were used, the time various operations took place, and other information may be logged and stored within storage devices 250 or data store 259 as metadata 112 or as other data.

User interface module 252 may manage user interactions with computing system 240. User interface module 252 may cause computing system 240 to output various user interfaces for display or presentation or otherwise, as a user of computing system 240 views, hears, or otherwise senses output and/or provides input at computing system 240 or at a remote computing system over a network. In some examples, user interface module 252 may receive information and instructions from a platform, operating system, application, and/or service executing at computing system 240, at a client device, and/or one or more remote computing systems. In addition, user interface module 252 may act as an intermediary between a platform, operating system, application, and/or service executing at client device and various output devices of such a client (e.g., speakers, LED indicators, audio or electrostatic haptic output devices, light emitting technologies, displays, etc.) to produce output (e.g., a graphic, a flash of light, a sound, a haptic response, etc.). In some examples, user interface module 252 may perform functions corresponding to user interface system 152 as illustrated in FIG. 1.

In some examples, user interface module 252 may generate a language or comply with a standard protocol associated with formatting metadata 112 and/or synthetic data 111. Such a language or format may enable third party vendors to read data in a common form and generate visualizations, user interfaces, or other ways to consume of metadata 112 and synthetic data 111. For example, a third party may develop a tool to read the data formatted in a standard language or protocol, capture specific underlying data, and generate a visualization that presents the data in a desired format. Different formats might be used for various purposes, such as for data analysis, verification, auditing, or regulatory compliance purposes, or for other purposes.

Machine learning module 253 may perform functions relating to training one or more production models 160 to make predictions or draw inferences about input data 161. In some examples, machine learning module 253 is a system or process that is capable of training a machine learning model (e.g., production model 160) by applying a machine learning process to training data 113. Machine learning module 253 may use actual production data (e.g., source datasets 101) as training data 113, where that actual production data is derived from data collected from processes relevant to production model 160 (e.g., customer data, information about input received by production business systems). In other examples, however, some or all of the training data 113 that machine learning module 253 uses to train production model 160 may be synthetic, such as synthetic data 111A and 111B. User machine learning module 253 may perform functions corresponding to machine learning system 153 illustrated in FIG. 1.

Data store 259 of computing system 240 may represent any suitable data structure or storage medium for storing information relating to generating and/or tracing synthetic data. The information stored in data store 259 may be searchable and/or categorized such that one or more modules within computing system 240 may provide an input requesting information from data store 259, and in response to the input, receive information stored within data store 259. Data store 259 may be primarily maintained by tracing module 251.

Modules illustrated in FIG. 2 (e.g., tracing module 251, user interface module 252, machine learning module 253) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

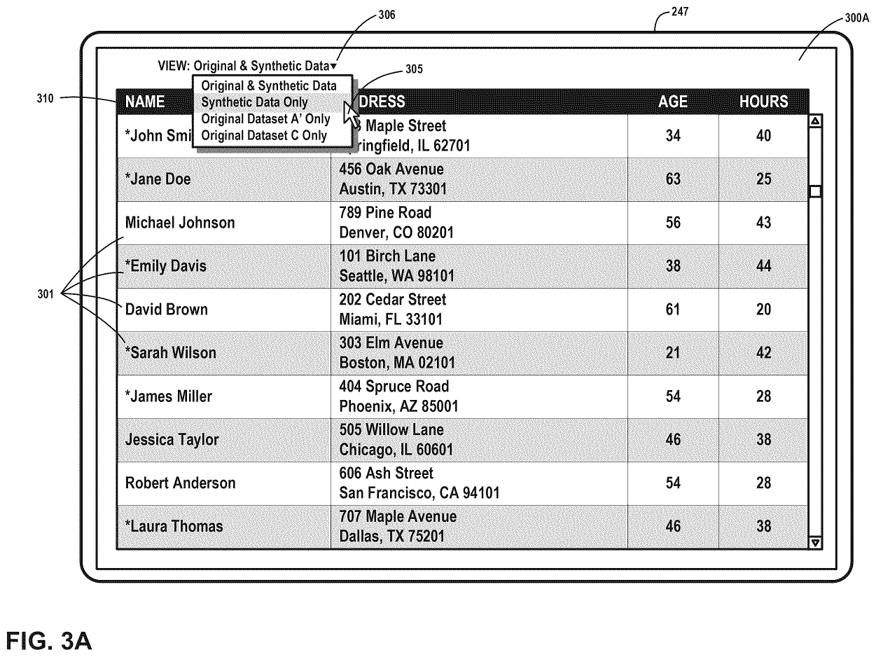

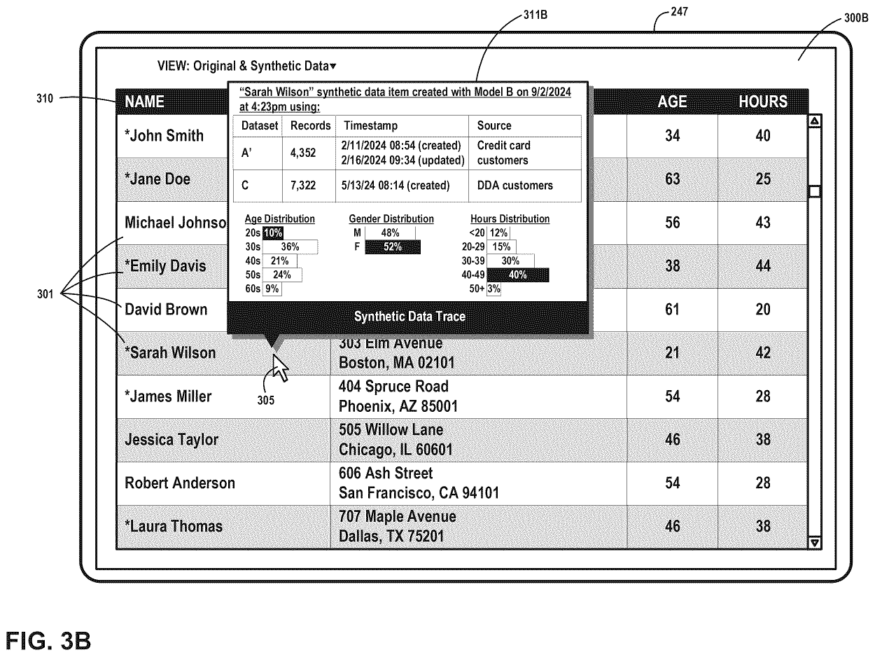

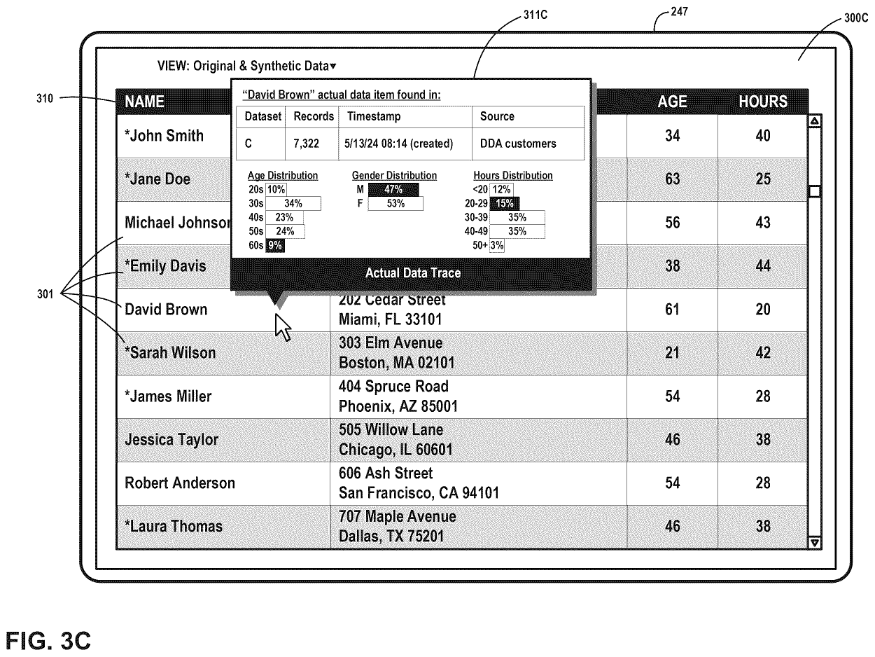

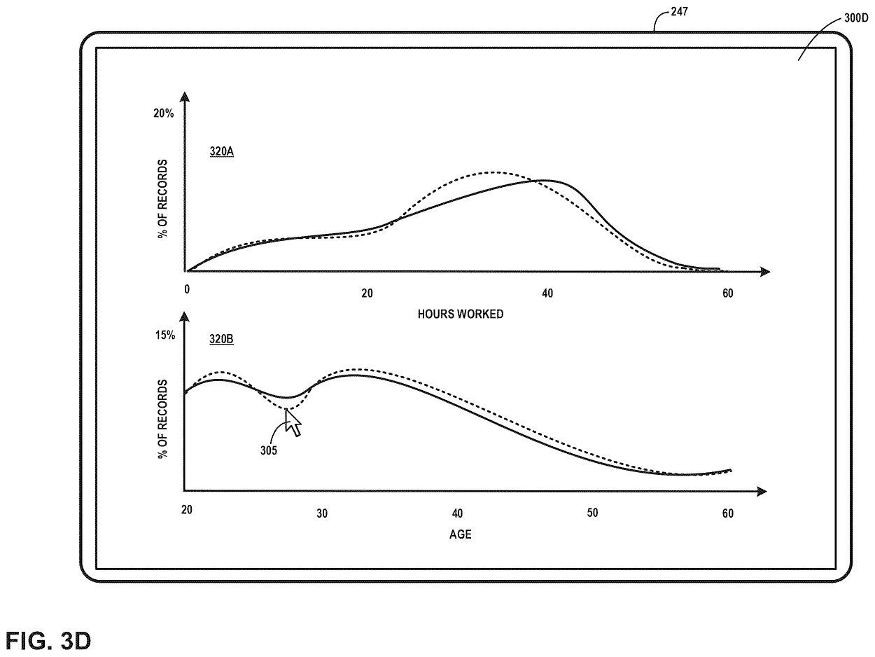

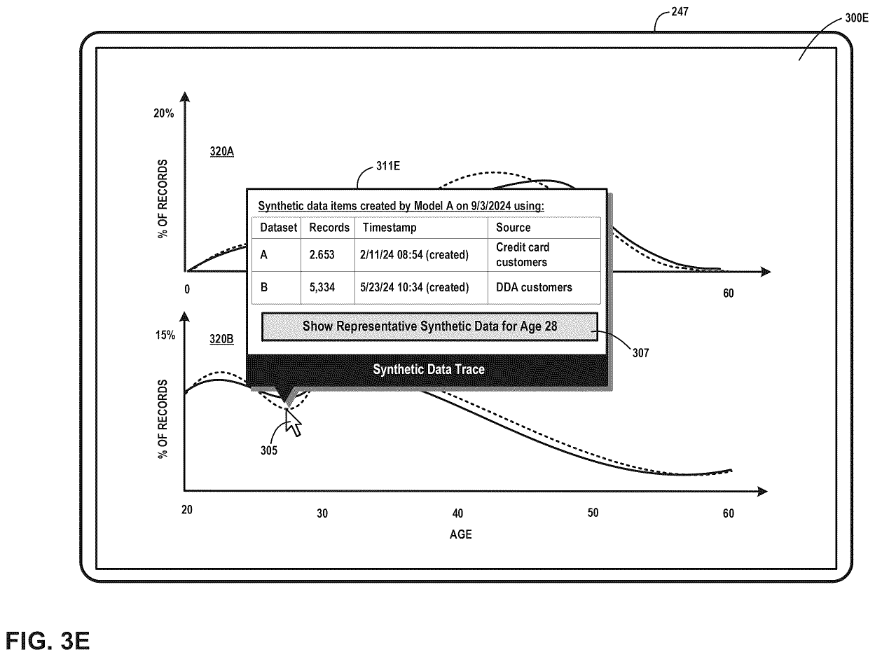

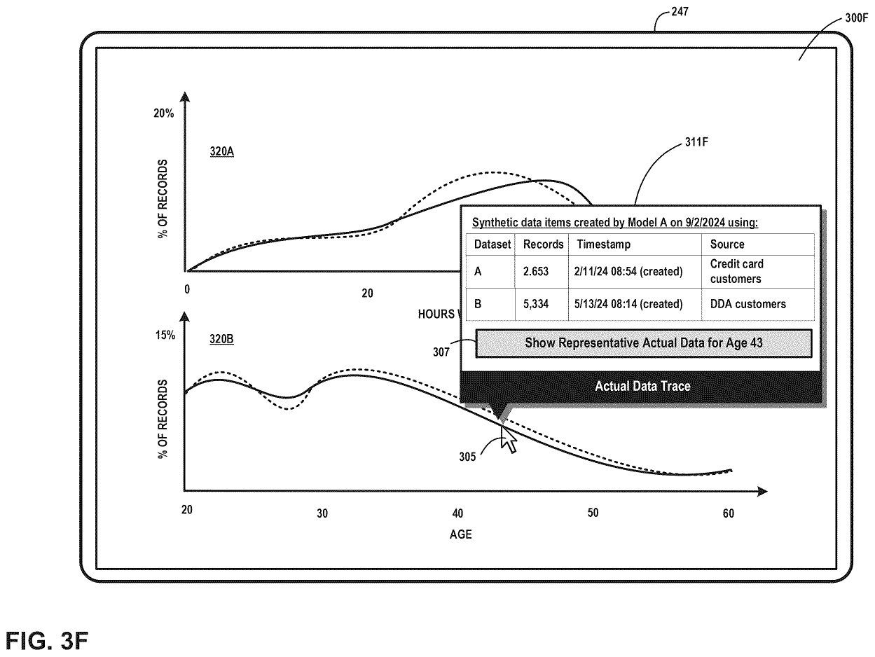

FIG. 3A through FIG. 3F are conceptual diagrams illustrating example user interfaces presented by a user interface device in accordance with one or more aspects of the present disclosure. Each of the user interfaces 300 presented in FIG. 3A through FIG. 3F (i.e., user interfaces 300A, 300B, 300C, 300D, 300E, and 300F, respectively) may correspond to user interface 300 presented or output by model development system 140 of FIG. 1. Each of user interfaces 300 may also be presented or output by computing system 240 of FIG. 2, and in such an example, any of user interfaces 300 may be presented by an output device, such as a display device included as part of computing system 240 of FIG. 2. Such a display device may be considered an example of an output device 247 of computing system 240. In some examples, such as where the display device is a presence-sensitive display (e.g., a “touch screen”), the display device may also serve as an example of an input device 246 of computing system 240.

Although the user interfaces illustrated in FIG. 3A through FIG. 3F are shown as graphical user interfaces, other types of interfaces may be presented in other examples. Such user interfaces may include a text-based user interface, a console or command-based user interface, a voice prompt user interface, or any other appropriate user interface now known or hereafter developed.

FIG. 3A is an example user interface providing a visualization of data that may be used in model development, where the data includes both source and generated synthetic data. In FIG. 3A, a display device (e.g., one of output devices 247) presents user interface 300A, which includes table 310. In the example illustrated, table 310 is a scrollable listing of individual data items 301 associated with the process of generating synthetic data 111B by model 110B. Such data items 301 may therefore include data items from source dataset 101A′ or source dataset 101C, or include data items drawn from the set of synthetic data 111B.

Table 310 in FIG. 3A presents example data columns (name, address, age, hours worked), with each of row in the table including the data corresponding to those columns or data fields. For ease of illustration, only a limited set of data fields (name, address, age, hours worked) are presented by table 310. However, in other examples, information about any number of data fields may be presented within table 310 or otherwise.

In the example being illustrated in FIG. 3A, synthetic data items are designated as synthetic with an asterisk character preceding the name within the name field. In other examples, color, highlighting, underlining, or any other appropriate technique may be used to enable a viewer to distinguish data items 301 that are generated synthetic data 111 rather than instances of data included within source datasets 101.

As illustrated in FIG. 3A, table 310 includes both data items from source datasets 101 as well as data items from synthetic data 111. However, filter control 306 can be used to filter the data items that are displayed within table 310. For example, computing system 240 may detect input that corresponds to interactions by a user with filter control 306 (e.g., a user's selection within the illustrated drop-down menu using cursor 305). In response to such interactions, table 310 might present only data items 301 drawn from source dataset 101A′ or 101C (if either “Original Dataset A′ Only” or “Original Dataset C Only” is selected from the drop-down menu) or might present only data items 301 from synthetic data 111B (if “Synthetic Data Only” is selected). Once filtered through interaction with filter control 306, table 310 may present only those data items 301 that satisfy the filter, with other data item 301 being hidden. Whether or not filtering is applied through interactions with filter control 306, user interfaces 300 illustrated in FIG. 3A through FIG. 3F may otherwise operate the same way as described herein.

FIG. 3B is another example user interface illustrating a visualization of attributes of one of data items 301 within table 310. In some examples, computing system 240 may present information about a specific synthetic data item. For instance, in an example that can be described with reference to FIG. 2 and FIG. 3B, input device 246 of computing system 240 in FIG. 2 detects input that user interface module 252 determines corresponds to a selection of one of the rows of table 310 with cursor 305 (see FIG. 3B). User interface module 252 of computing system 240 determines that the selected row is the row corresponding to the “Sarah Wilson” synthetic data item 301. Responsive to this interaction, user interface module 252 accesses information about the synthetic data item 301 for Sarah Wilson (e.g., as part of synthetic data 111B and metadata 112B stored within storage devices 250 or data store 259). User interface module 252 generates information sufficient to render an updated user interface that includes information about the Sarah Wilson data item 301. User interface module 252 uses the data to cause the display device to present user interface 300B, which includes details window 311B as illustrated in FIG. 3B.

In FIG. 3B, details window 311B presents additional information about the selected synthetic data item 301. As illustrated, details window 311B specifies information about the model that generated the selected synthetic data item 301 (i.e., model “B,” which may correspond to model 110B in FIG. 2), the datasets the model used to create the synthetic data, and other information. As indicated in details window 311B, model B used an updated version of dataset A (which may correspond to source dataset 101A′ in FIG. 2) and dataset C (which may correspond to source dataset 101C in FIG. 2). Also as indicated in details window 311B, source dataset 101A′ may be derived from records associated with actual credit card customers, and source dataset 101C may be derived from records associated with actual direct deposit account customers.

Details window 311B also includes information about attributes of a composite dataset (the combination of source dataset 101A′ and source dataset 101C) that model B used to generate synthetic data. Specifically, details window 311B provides distribution information that describes the combination of dataset A′ and dataset C, including distribution information about age, gender, and hours worked attributes of the combined dataset. For each attribute, the corresponding value for Sarah Wilson may be provided, or as illustrated in details window 311B, an indication of where that corresponding value falls in the distribution of the combined dataset. In details window 311B, for example, the data bin corresponding to the underlying data value for Sarah Wilson is highlighted within each histogram provided in details window 311B. In other words, since Sarah Wilson is 21, female, and works an average of 42 hours per week, the “20s” age bar is shown highlighted (i.e., with a black background), the “female” gender bar is shown highlighted, and the “40-49” hours category bar is also shown highlighted. This distribution information in details window 311B corresponds to the distribution of the source, input, or training data that was used by model “B” to generate the Sarah Wilson data item. Alternatively, or in addition, distribution information for the synthetic data could also be presented within details window 311B or otherwise.

The example information illustrated in details window 311B of FIG. 3B provides one possible example, but any relevant or useful data can be presented in various contexts within a given details window 311. For example, and in general, any of details windows 311 illustrated herein might provide information about the source, size, volume, freshness, completeness, update schedule, and timestamps associated with the appropriate source datasets 101 (in the example of FIG. 3B, source dataset 101A′ and source dataset 101C) and whether all or a portion of such source datasets 101 were used. Also, a details window 311 might provide information about the source of a given set of source dataset 101, and specifically whether it was received directly from the original source (e.g., census data received directly from the government as the original source) or whether it was processed by a third party.

FIG. 3C is an example user interface illustrating details about a different data item 301. In some examples, computing system 240 may present information about a non-synthetic data item. For instance, in an example that can be described with reference to FIG. 2 and FIG. 3C, input device 246 of computing system 240 detects input that user interface module 252 determines corresponds to a selection of one of the rows of table 310. User interface module 252 further determines that the selected row corresponds to a non-synthetic data item, such as the data item 301 associated with David Brown. In response to this interaction, user interface module 252 accesses metadata 112 about the original data for David Brown (which may be part of one of source datasets 101A′ or 101C stored within storage devices 250 or data store 259). User interface module 252 generates an updated user interface and causes the display device to present user interface 300C as illustrated in FIG. 3C.

FIG. 3C is similar to FIG. 3B, but since the selected data item was an actual data item, rather than a synthetic data item, details window 311C may provide different information. For example, since the selected data item 301 for David Brown is actual data that was not generated by a model, details window 311C does not include information about a model (since no model was used to create the David Brown data item). Also, only one dataset is identified, since in the example being described, the David Brown data item 301 was drawn from one specific dataset (i.e., dataset C or source dataset 101C in FIG. 2). Further, the distribution information and corresponding values for David Brown in details window 311C may correspond to the actual values for just dataset C, rather than for a combined or composite dataset, as in FIG. 3B.

FIG. 3D is an example user interface illustrating distribution information for both synthetic data and the source data used to generate that synthetic data. FIG. 3D shows a user interface 300D illustrating distributions (or histograms) for specific data fields common to both the source data and synthetic data generated from the source data. In the example shown, data from the “hours worked” and “age” fields are illustrated in distribution graphs 320A and 320B, respectively. In other examples, additional graphs or histograms may be provided for other data fields or other attributes of the source or synthetic data.

In user interface 300D, and for both distribution graph 320A and distribution graph 320B, the solid line is intended to represent a distribution of the actual source data for a particular data field, and the dotted line is intended to represent a distribution of the generated synthetic data for that same data field. Accordingly, the extent to which the generated synthetic data has distribution characteristics matching those of the underlying source data can be determined based on the extent that the dotted line matches the solid line.

FIG. 3E and FIG. 3F are example user interfaces illustrating the distributions of FIG. 3D as well as details about the synthetic data and the underlying source data. In some examples, computing system 240 may present specific information about one or more of the illustrated distributions. For instance, in an example that can be described with reference to FIG. 2 and FIG. 3E, input device 246 detects input that user interface module 252 determines corresponds to a selection, with cursor 305, of the dotted line in distribution graph 320B. User interface module 252 determines that this interaction with user interface 300E corresponds to a request to display information about the underlying synthetic data represented by distribution graph 320B. In response to the request, user interface module 252 accesses metadata 112 about the synthetic data associated with the dotted line. User interface module 252 generates information sufficient to render an updated user interface and causes a display device to present user interface 300E that includes details window 311E, as illustrated in FIG. 3E.

In FIG. 3E, details window 311E presents information relevant to the user's interaction with user interface 300E. In one example, the synthetic data represented by distribution graph 320B may correspond to synthetic data 111A generated by model 110A based on source datasets 101A and 101B (see FIG. 2). Since the interaction with user interface 300E involved a selection of the dotted line in distribution graph 320B, details window 311E specifies information about the model that generated the synthetic data, the datasets the model (i.e., model 110A) used to create the synthetic data (i.e., source datasets 101A and 101B), and in some cases, additional information.

Details window 311E also includes button 307, which, when selected by a user, may cause user interface module 252 to present representative synthetic data drawn from synthetic data 111A. For example, since cursor 305 is positioned near the x-axis age value of 28 in distribution graph 320B, selection of 307 may cause user interface module 252 of computing system 240 to generate and present information about a selection of synthetic data items 301 (e.g., in a table similar to table 310 in FIG. 3A) where those synthetic data items have age field with a value at or near 28.

FIG. 3F is similar to FIG. 3E, except that user interface 300F includes details window 311F, which may be presented in response to selection of the solid line in FIG. 3E using cursor 305. Details window 311F is similar to details window 311E, in that it presents information about the datasets that were used to create synthetic data. However, button 307, if selected using cursor 305 in FIG. 3F, may cause user interface module 252 to present representative source data (i.e., from datasets A or C) rather than synthetic data, as in FIG. 3E. For example, since cursor 305 is positioned near age 43 in distribution graph 320B in FIG. 3F, selection of 307 in FIG. 3F may cause user interface module 252 to generate and present information about records from actual source data (e.g., from either source dataset A or B) where those source data items have age field with a value at or near 43.

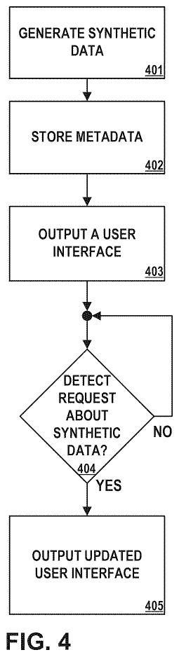

FIG. 4 is a flow diagram illustrating operations performed by an example computing system in accordance with one or more aspects of the present disclosure. FIG. 4 is described in the context of computing system 240 of FIG. 2. In other examples, operations described in FIG. 4 may be performed by other systems or devices. Further, in other examples, operations described in connection with FIG. 4 may be merged, performed in a difference sequence, omitted, or may encompass additional operations not specifically illustrated or described.

In the process illustrated in FIG. 4, and in accordance with one or more aspects of the present disclosure, computing system 240 may generate a plurality of synthetic data items (401). For example, with reference to FIG. 2, input device 246 of computing system 240 detects input and outputs information about the input to tracing module 251. Tracing module 251 determines that the input corresponds to source dataset 101A and source dataset 101B. Tracing module 251 presents source dataset 101A and source dataset 101B to model 110A and causes model 110A to generate synthetic data 111A. Tracing module 251 monitors the generation of synthetic data 111A by model 110A.

Computing system 240 may store metadata about how the plurality of synthetic data items was generated (402). For example, again with reference to FIG. 2, tracing module 251 of computing system 240 collects information or metadata 112A about the synthetic data creation process when model 110A generates synthetic data 111A. Tracing module 251 logs or stores metadata 112A in storage device 250. Metadata 112A may include information about the model used to generate synthetic data 111A, the time the model was executed, information about the source datasets 101 used to generate synthetic data 111A, information about any errors or exceptions generated during the process, information about the computing systems used to generate the synthetic data 111A, the time taken to generate synthetic data 111A, and/or other information about the synthetic data creation process. In some examples, tracing module 251 logs or stores metadata 112A with the synthetic data 111A, so that it travels with and stays with synthetic data 111A. In some cases, metadata 112A may integrated int synthetic data 111A.

Computing system 240 may output a user interface presenting information about the plurality of synthetic data items (403). For example, tracing module 251 outputs information about synthetic data 111A and/or metadata 112A to user interface module 252. User interface module 252 generates a visualization or user interface presenting information about source dataset 101A, source dataset 101B, and/or synthetic data 111A. User interface module 252 outputs the user interface to output device 247. In some examples, output device 247 is a display device that presents the user interface in a form similar to user interface 300A of FIG. 3A or user interface 300D of FIG. 3D.

Computing system 240 may detect, based on interactions with the user interface, a request to present information about one or more specific data items (404). For example, input device 246 detects an interaction with the user interface presented by output device 247. Input device 246 outputs information about the interaction to user interface module 252. User interface module 252 determines that the interaction corresponds to a request to present information about one or more data items represented in some way in the user interface (YES path from 404).

Computing system 240 may output, based on the metadata and responsive to the request, an updated user interface presenting information about how the one or more specific data items were generated (405). For example, tracing module 251 identifies the one or more data items associated with the request to present information about selected data item(s). Tracing module 251 accesses metadata 112A and uses the metadata 112A to cause user interface module 252 to generate an updated user interface, providing information about how the identified data item(s) were generated. User interface module 252 causes output device 247 to present the updated user interface. In some examples, output device 247 may present the updated user interface in a form similar to user interface 300B of FIG. 3B, user interface 300C of FIG. 3C, user interface 300E of FIG. 3E, or user interface 300F of FIG. 3F.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any material that is incorporated by reference conflicts with the present disclosure, the present disclosure shall control.

For ease of illustration, only a limited number of devices (e.g., user interface system 152, machine learning system 153, computing system 240, as well as others) are shown within the illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The illustrations included herein depict at least one example implementation of an aspect of this disclosure. The scope of this disclosure is not, however, limited to such implementations. Accordingly, other example or alternative implementations of systems, methods or techniques described herein, beyond those illustrated, may be appropriate in other instances. Such implementations may include a subset of the devices and/or components included in the illustrations and/or may include additional devices and/or components not specifically illustrated.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced illustrations in order to avoid obscuring such concepts.

Accordingly, although one or more implementations of various systems, devices, and/or components may be described with reference to specific illustrations, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated herein may alternatively be implemented as part of another device or component not shown in such illustrations. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner. References herein to “real time” or equivalent phrases are intended to encompass near-real time or seemingly near-real time, such as from the perspective of a reasonable human observer.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, graphics processing units (GPUs), application specific integrated circuits (ASICs), field programmable logic arrays (FPGAs), quantum processors, or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including, to the extent appropriate, a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
generating, by a computing system and based on a source dataset, a plurality of synthetic data items;
storing, by the computing system, metadata about how the plurality of synthetic data items were generated;
outputting, by the computing system, a user interface presenting information about the plurality of synthetic data items;
detecting, by the computing system and based on interactions with the user interface, a request to present information about one or more specific synthetic data items included in the plurality of synthetic data items; and
outputting, by the computing system based on the metadata and responsive to the request, an updated user interface presenting information about how the one or more specific synthetic data items were generated.

2. The method of claim 1, wherein the one or more specific synthetic data items is one specific synthetic data item, and wherein detecting the request to present information about the one specific synthetic data item includes:
detecting interactions with a listing of at least some of the plurality of synthetic data items, including the one specific synthetic data item.

3. The method of claim 2, wherein outputting the updated user interface includes:
outputting information identifying a model used to generate the one specific synthetic data item and information about the source dataset used by the model to generate the one specific synthetic data item.

4. The method of claim 1, wherein the one or more specific synthetic data items is a plurality of specific synthetic data items having a common attribute, and wherein detecting the request to present information about the plurality of specific synthetic data items includes:
detecting interactions with a line in a graph presenting information about the plurality of synthetic data items.

5. The method of claim 4, wherein outputting the updated user interface includes:
identifying, based on the interactions with the line in the graph and the metadata, the plurality of specific synthetic data items having the common attribute; and
outputting information about at least some of the plurality of specific synthetic data items having the common attribute.

6. The method of claim 1,
wherein generating the plurality of synthetic data items includes generating, based on a plurality of source datasets, the plurality of synthetic data items, each of the source datasets including a plurality of source data items; and
wherein the user interface further presents information about the plurality of source data items.

7. The method of claim 6, wherein the updated user interface is a first updated user interface, and wherein the method further comprises:
detecting, by the computing system and based on interactions with the user interface, a request to present information about a specific source data item included in the plurality of source data items; and
outputting, by the computing system and responsive to the request to present information about the specific source data item, a second updated user interface presenting information about which of the plurality of source datasets includes the specific source data item.

8. The method of claim 1, wherein the updated user interface is a first updated user interface, and wherein the method further comprises:
detecting, by the computing system and based on interactions with the user interface, a request to present information about one or more specific source data items having a common attribute; and
outputting, by the computing system based on the metadata and responsive to the request to present information about the one or more specific source data items, a second updated user listing at least some of the one or more specific source data items having the common attribute.

9. The method of claim 1, wherein generating the plurality of synthetic data includes:
generating the plurality of synthetic data items using one or more neural networks.

10. The method of claim 1, further comprising:
training, by the computing system, a machine learning model using the synthetic data;
applying, by the computing system, the machine learning model to input data to make a prediction; and
sending, by the computing system and based on the prediction, control signals to an external system, instructing the external system to perform an operation.

11. A computing system comprising processing circuitry and a storage device, wherein the processing circuitry has access to the storage device and is configured to:
generate, based on a source dataset, a plurality of synthetic data items;
store metadata about the how the plurality of synthetic data items were generated;
output a user interface presenting information about the plurality of synthetic data items;
detect, based on interactions with the user interface, a request to present information about one or more specific synthetic data items included in the plurality of synthetic data items; and
output, based on the metadata and responsive to the request, an updated user interface presenting information about how the one or more specific synthetic data items were generated.

12. The computing system of claim 11, wherein the one or more specific synthetic data items is one specific synthetic data item, and wherein to detect the request to present information about the one specific synthetic data item, the processing circuitry is further configured to:
detect interactions with a listing of at least some of the plurality of synthetic data items, including the one specific synthetic data item.

13. The computing system of claim 12, wherein to output the updated user interface, the processing circuitry is further configured to:
output information identifying a model used to generate the one specific synthetic data item and information about the source dataset used by the model to generate the one specific synthetic data item.

14. The computing system of claim 11, wherein the one or more specific synthetic data items is a plurality of specific synthetic data items having a common attribute, and wherein to detect the request to present information about the plurality of specific synthetic data items, the processing circuitry is further configured to:
detect interactions with a line in a graph presenting information about the plurality of synthetic data items.

15. The computing system of claim 14, wherein to output the updated user interface, the processing circuitry is further configured to:
identify, based on the interactions with the line in the graph and the metadata, the plurality of specific synthetic data items having the common attribute; and
output information about at least some of the plurality of specific synthetic data items having the common attribute.

16. The computing system of claim 11,
wherein to generate the plurality of synthetic data items, the processing circuitry is further configured to generating, based on a plurality of source datasets, the plurality of synthetic data items, each of the source datasets including a plurality of source data items; and
wherein the user interface further presents information about the plurality of source data items.

17. The computing system of claim 16, wherein the updated user interface is a first updated user interface, and wherein the processing circuitry is further configured to:
detect, based on interactions with the user interface, a request to present information about a specific source data item included in the plurality of source data items; and
output, responsive to the request to present information about the specific source data item, a second updated user interface presenting information about which of the plurality of source datasets includes the specific source data item.

18. The computing system of claim 11, wherein the updated user interface is a first updated user interface, and wherein the processing circuitry is further configured to:
detect, based on interactions with the user interface, a request to present information about one or more specific source data items having a common attribute; and
output, based on the metadata and responsive to the request to present information about the one or more specific source data items, a second updated user listing at least some of the one or more specific source data items having the common attribute.

19. The computing system of claim 11, wherein generating the plurality of synthetic data, the processing circuitry is further configured to:
generate the plurality of synthetic data items using one or more neural networks.

20. Non-transitory computer-readable media comprising instructions that, when executed, cause processing circuitry of a computing system to:
generate, based on a source dataset, a plurality of synthetic data items;
store metadata about the how the plurality of synthetic data items were generated;
output a user interface presenting information about the plurality of synthetic data items;
detect, based on interactions with the user interface, a request to present information about one or more specific synthetic data items included in the plurality of synthetic data items; and
output, based on the metadata and responsive to the request, an updated user interface presenting information about how the one or more specific synthetic data items were generated.
